(19) United States
(12) Patent Application Publication
(10) Pub. No.: US 2004/0003213 A1
(43) Pub. Date: Jan. 1, 2004

(54) Method for reducing the latency of a branch target calculation by linking the branch target address cache with the call-return stack

(76) Inventors: John W. Bockhaus, Fort Collins, CO (US); Douglas B. Hunt, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/186,935

(22) Filed: Jun. 28, 2002

(51) Int. Cl. G06F 7/38; G06F 9/00; G06F 9/44

(52) U.S. Cl. 712/233

(57) ABSTRACT

An embodiment of the invention provides a circuit and method for reducing latency when a branch occurs that references a call-return stack (CRS). When an entry to a branch target address cache (BTAC) is added, a flag is set in that entry if the branch has a reference to a CRS. If the branch does not have a reference to a CRS, a flag is not set. When a branch occurs during execution of code, that branch may be associatively mapped to a previously stored branch in the BTAC. If the flag stored along with the previously stored branch is set, the code goes to the address found at the top of the CRS. If the flag is not set, the program uses the target address found in the BTAC.

### FIELD OF THE INVENTION

This invention relates generally to microprocessor performance. More particularly, this invention relates to reducing latency in a branch target calculation.

### BACKGROUND OF THE INVENTION

Branches taken during the execution of otherwise sequential code may reduce the effectiveness of CPU operation. Predicting the outcome of a branch ahead of time permits the correct target instruction stream to be fetched for execution early, improving pipeline efficiency and resource utilization. Branching behavior is workload dependent and ranges from completely predictable unconditional branches, to almost predictable branches for loops, and dynamic data dependent branches that may be impossible to predict statically. Branch prediction schemes can be classified into static and dynamic schemes.

Static methods are usually carried out by the compiler. They are static because the prediction is already known before the program is executed. One static prediction scheme predicts all branches to be taken. This makes use of the observation that a majority of branches are taken. This primitive mechanism may yield 60% to 70% accuracy. Another static prediction scheme uses the direction of a branch to base its prediction. Profiling can also be used to predict the outcome of a branch. A previous run of the program is used to collect information as to whether a given branch is likely to be taken, and this information is included in the opcode of the branch.

Dynamic branch prediction schemes are different from static mechanisms because they use the run-time behavior of branches to make more accurate predictions than possible using static prediction. Usually information about outcomes of previous occurrences of a given branch is used to predict the outcome of the current occurrence. One approach used to make dynamic conditional branch predictions is a Branch History Table (BHT). A BHT usually includes a table of two-bit saturating counters which is indexed by a portion of the branch address.

An approach used to predict branch target addresses is a Branch Target Address Cache (BTAC). A typical BTAC is an associative memory where the addresses of branch instructions are stored together with their predicted target addresses. When a branch is encountered for the first time, a new entry is created when the branch target address is resolved. When that branch is encountered again, its instruction address will match an address stored in the BTAC, and the BTAC target address may be used to fetch the next set of instructions immediately. In some CPUs, this BTAC hit may occur even before the instruction is identified as a branch. A BTAC hit may reduce or eliminate the time otherwise wasted due to waiting for the instructions to be fetched from the icache, decoding whether any one of them is a branch instruction, or calculating the branch's target address. As a result, the BTAC increases the performance of a CPU by quickly predicting the branch's target address.

Another approach used for branch prediction is a Branch Target Instruction Cache (BTIC). This is a variation of a BTAC. A BTIC caches the instruction(s) at the target of the branch instead of just the target address. This eliminates the need to fetch the target instructions from the instruction cache or from memory.

In any branch prediction scheme, the prediction may be wrong. The branch direction may be predicted incorrectly. In addition, the branch's target address may be predicted incorrectly. If either one of these happen, some number of cycles will be lost. This situation is called a mispredicted branch penalty.

A procedure is a piece of code that is called and executed. Instead of repeating the same piece of code in a program, the procedure may be called from many locations and executed. A procedure may also call another procedure. This is known as nesting. A procedure may be nested within many levels of procedures. After a procedure has been executed, a return is made to the point immediately after the procedure call. This point may be located in the main program code or it may be in another procedure if several procedures have been nested.

A last-in-first-out stack is used to keep track of the return points in a nested procedure program. This stack is commonly called a call-return stack (CRS). The “top” of the call-return stack contains the return point for the most recently executed procedure. After a procedure has been executed, the program returns to the location indicated at the top of the stack. The location at the top of the stack is then removed and the location just below the top of the stack is moved to the top. After the next procedure has been executed, the next address at the top of the stack is used to return to the location in the code where the last call to a procedure occurred. Thus, the CRS is generally very accurate in predicting the correct target address of a return.

When a branch occurs that involves a CRS, latency may be introduced into the instruction stream because the address at the top of the CRS cannot be used until the instruction is known to be a return instruction. This introduces latency in the pipeline from when the instruction address is known until the instructions are returned from the icache and can be decoded to determine whether any one of them is a return instruction. There is a need in the art to reduce this latency while maintaining an accurate prediction.

This invention meets the need of reducing latency caused when a branch involves a call-return stack by including a flag with entries made into a BTAC. When an entry in the BTAC is accessed, the CPU checks the flag. If the flag is set, the CPU goes immediately to the address found at the top of the CRS. If the flag is not set, the CPU goes to the target address found in the BTAC.

### SUMMARY OF THE INVENTION

An embodiment of the invention provides a circuit and method for reducing latency when a branch occurs that references a call-return stack. When an entry to a branch target address cache (BTAC) is added, a flag is set in that entry if the branch has a reference to a CRS. In one embodiment, this means the branch is a return instruction. If the branch does not have a reference to a CRS, a flag is not set. The flag may be a single extra bit in the BTAC, for example. When a branch occurs during execution of code, that branch may be associatively mapped to a previously stored branch in the BTAC. If the flag stored along with the previously stored branch is set, the code branches to the address at the top of the CRS. If the flag is not set, the program uses the target address found in the BTAC. This embodiment makes use of the quicker prediction time of the BTAC combined with the more accurate prediction of the CRS.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a drawing of a clock signal illustrating the relationship of branching and latency. Prior Art

FIG. 2 is a block diagram illustrating the function of a branch target address cache (BTAC). Prior Art

FIG. 3 is a drawing of a clock signal and a block diagram of BTAC illustrating how a BTAC may be used to reduce latency when the target address is correct. Prior Art

FIG. 4 is a drawing of a clock signal and a block diagram of BTAC illustrating how a BTAC does not reduce latency when the target address is incorrect. Prior Art

FIG. 5 is a drawing illustrating how a call return stack (CRS) stores the return address of a procedure. Prior Art

FIG. 6 is a drawing illustrating how return addresses are used and removed from a CRS. Prior Art

FIG. 7 is a drawing of a clock signal and a block diagram of CRS illustrating how latency is introduced in a pipeline by a CRS. Prior Art

FIG. 8 is a drawing of a clock signal, a block diagram of BTAC, and a CRS illustrating how a BTAC and a CRS may be used together to reduce latency.

### DETAILED DESCRIPTION OF THE PREFERRED EMBODIMENT

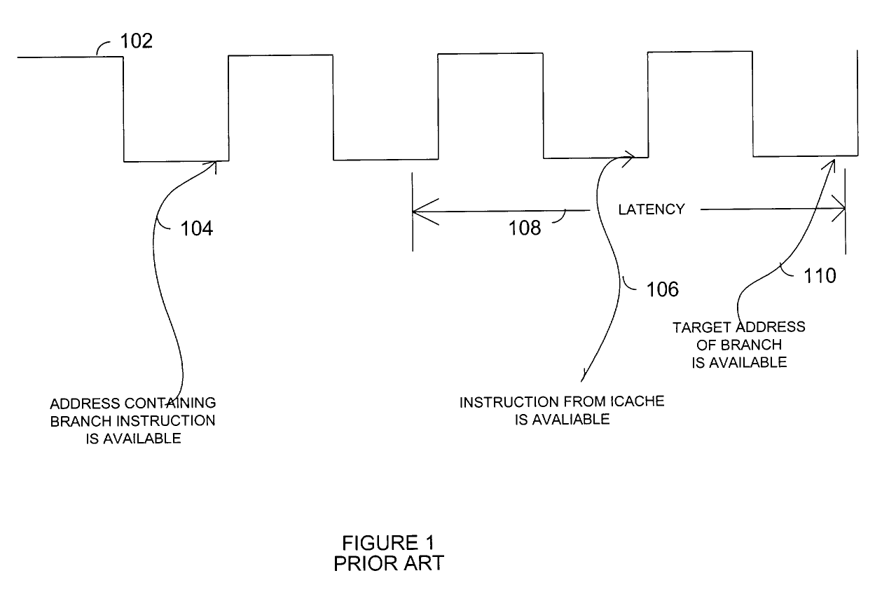

FIG. 1 contains a drawing of an example of a clock voltage waveform, 102 used to clock operations on a CPU. When a branch, 104, occurs during the execution of code on a CPU, it may take several cycles before the instruction, 106, from the ICACHE may be made available. It is not until the instruction is available that we know it is a branch. The target address of the branch, 110, can then be calculated once the instruction is known. The time delay, 108, incurred when a branch is taken is referred to as latency. More latency may decrease the overall performance of the CPU. In order to reduce latency, branch target address caches (BTACs) may be utilized.

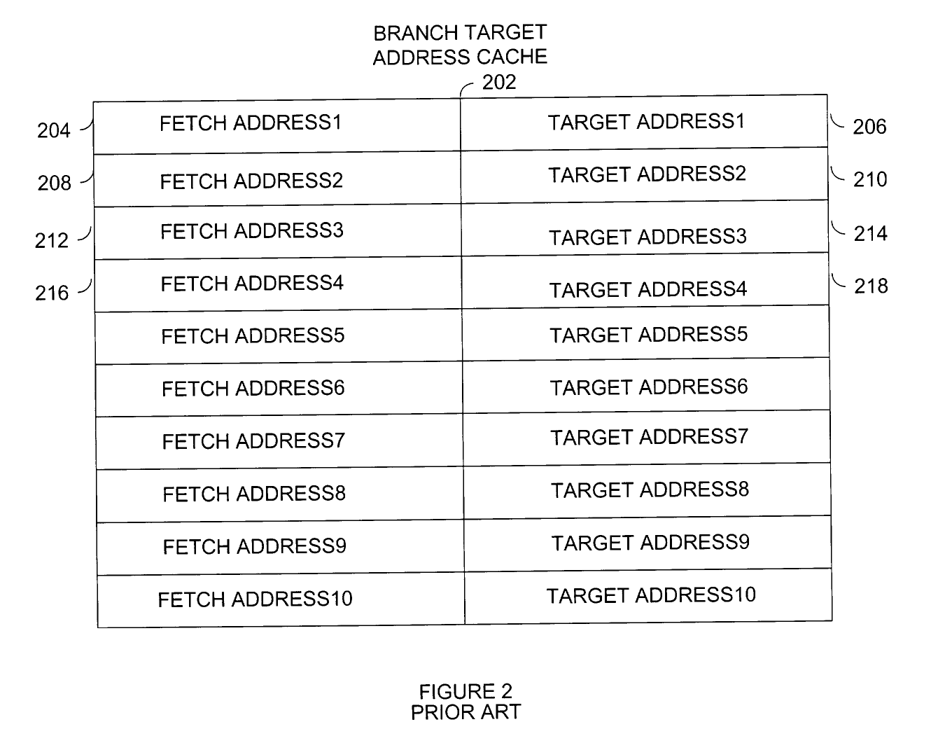

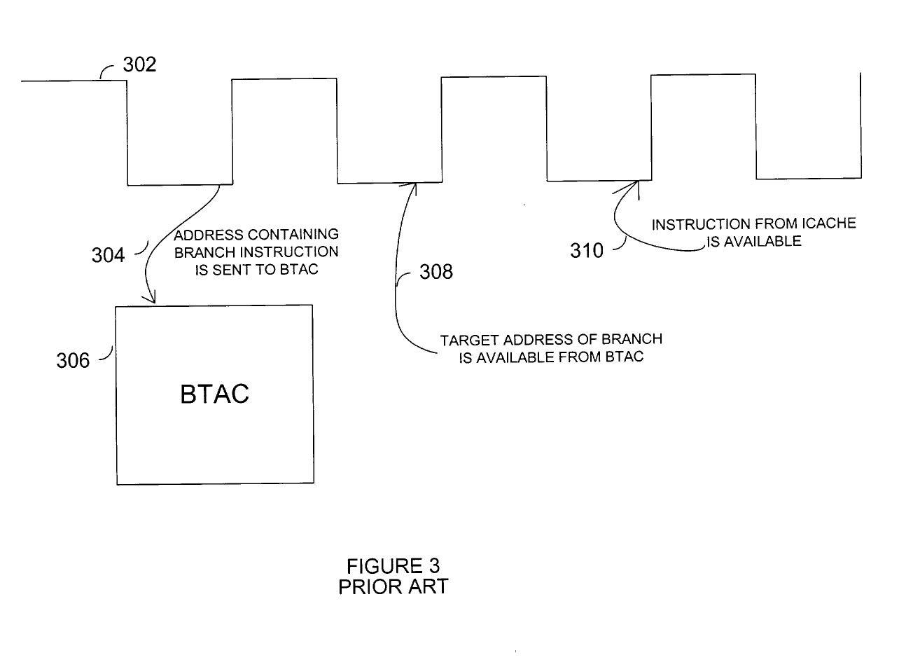

FIG. 2 shows a diagram of the functional structure of a BTAC. A BTAC stores the fetch and target addresses of previously taken branches, 204, 206, 208, 210, 212, 214, 216, and 218. FIG. 3 illustrates how latency may be reduced when using a BTAC. When a subsequent branch is taken, 304, during a particular phase of a clock, 302, the CPU will associatively look for a match of a fetch address in the BTAC, 306. If there is a match, the CPU will go directly to the target address associated with the matched fetch address, 308, and no additional latency is incurred. The branch instruction, 310, corresponding to the fetch address, 304, may be returned from the icache after its target address was delivered by the BTAC.

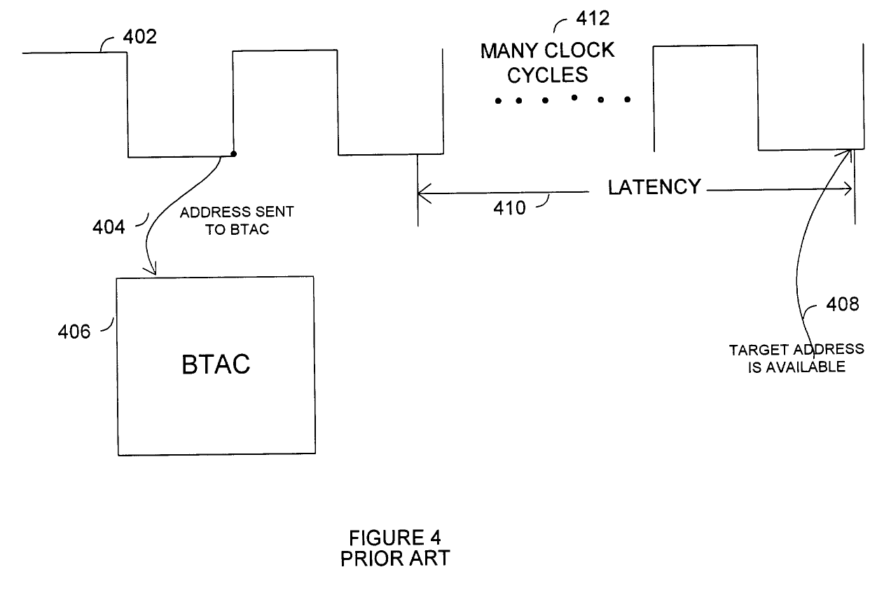

FIG. 4 illustrates what happens if the target address taken from a BTAC is incorrect. When a subsequent branch is taken, 404, during a particular phase of a clock, 402, the CPU will associatively look for a match of a fetch address in the BTAC, 406. If there is a match, the CPU will go directly to the target address associated with the matched fetch address. If the target address is incorrect, the correct target address, 408, will occur with latency, 410. This latency may be much longer, 412, than the latency shown in FIG. 1.

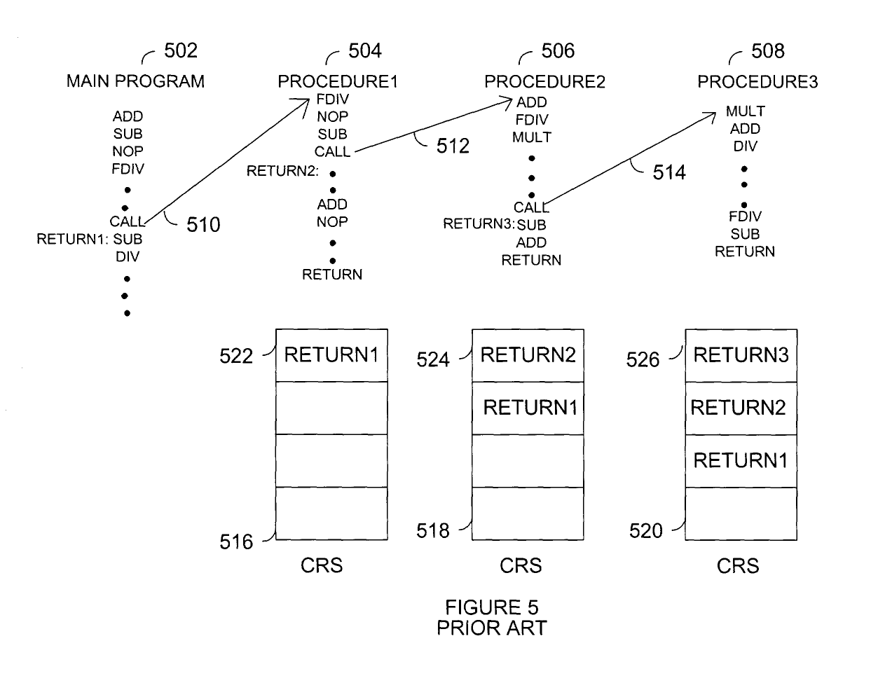

FIG. 5 illustrates how a call-return stack (CRS) may function. A main program, 520, executes code until it encounters a call instruction. When the main program encounters a call instruction, program execution, 510, branches to procedural, 504 and executes the code found in procedure1, 504. The return address, return1, 522, for procedure1, 504, is stored at the top of the CRS, 516. Since procedure1, 504 contains a call instruction, the execution of code now branches, 512 to procedure2, 506 and begins to execute the code found in procedure2, 506. The return address, return2, 524, for procedure2, 506 is now stored at the top of the CRS, 518, and return1, 522, is pushed down the stack. Since procedure2, 506, contains a call instruction, the execution of code now branches, 514 to procedures, 508 and begins to execute the code found in procedures, 508. The return address, return3, 526, for procedure3, 508, is now stored at the top of the CRS, 520, and return1, 522, and return2, 524 addresses are pushed down the stack. After this sequence, three addresses, 522, 524, and 526 are stored in the CRS, 520.

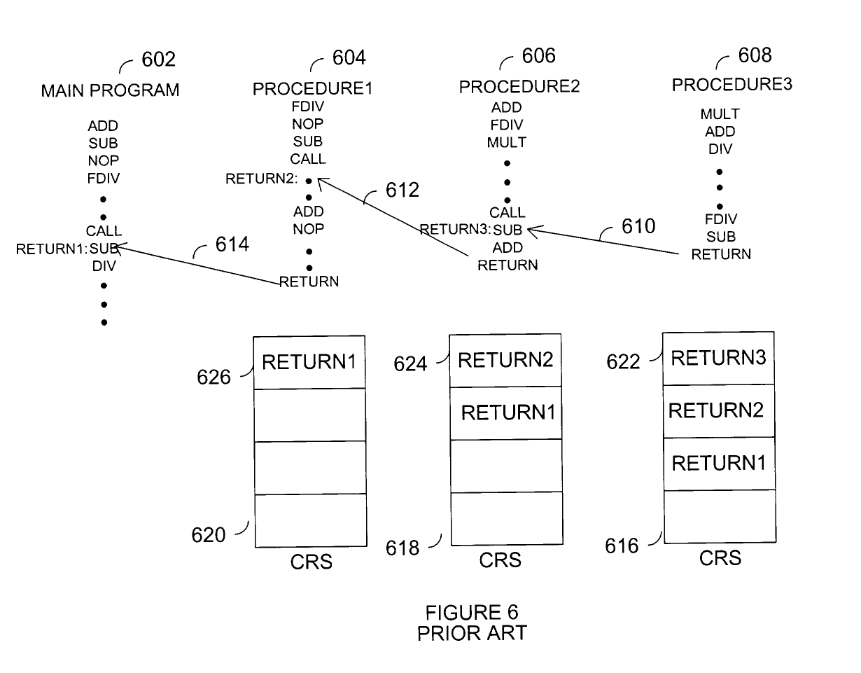

FIG. 6 illustrates how an address at the top of the CRS may be used as each procedure ends. When procedure3, 608, ends, the return address, return3, 622, at the top of CRS, 616 is taken, 610, and the program continues with the code in procedure2, 606. When the procedure2, 606, is finished, the program returns, 612, to the return address, return2, 624, found at the top of CRS, 618 and the program continues with the code in procedure1, 604. When the procedures, 604, ends, the return address, return1, 626, at the top of CRS, is taken, 614, and the program continues with the code found in the main program, 602.

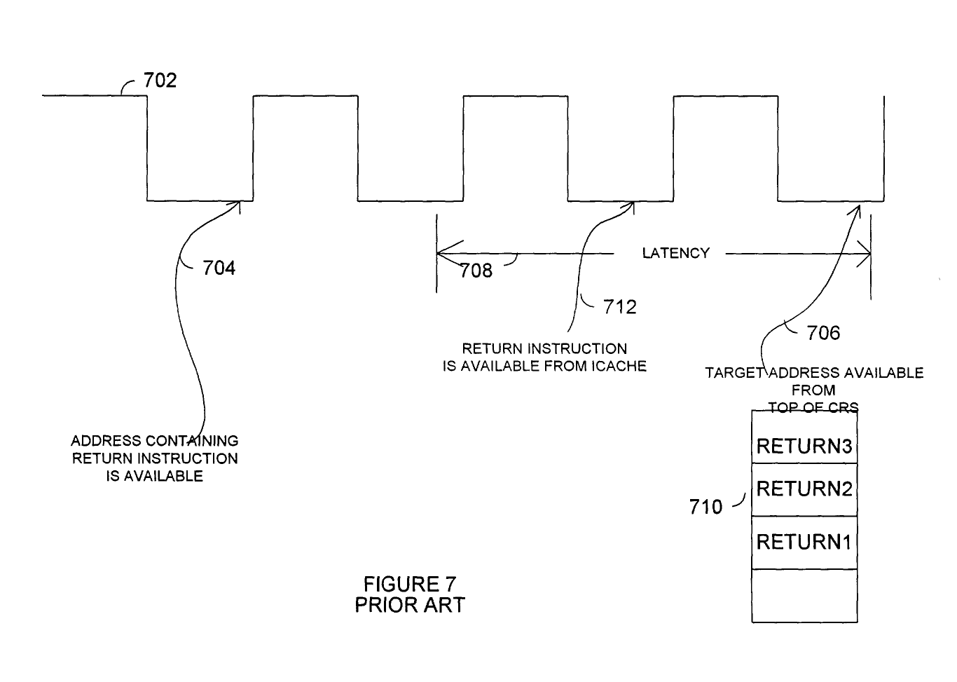

When a return instruction is encountered, it may create latency in the pipeline. FIG. 7 illustrates the latency that may be created when a return instruction's target address is predicted using a CRS. A clock signal is represented by waveform 702. When a return instruction, 704, is encountered in the instruction stream, the CRS, 710, may be used to predict the return's target address, 706. However, it is not known until later in the pipeline that this instruction is a return instruction. Once the instruction has been returned from the icache and decoded as a return instruction, the top of the CRS may be used as its target address, 706. This time delay in determining whether this instruction is a return results in latency, 708. The return instruction, 704, would be placed in the BTAC to enable a quicker prediction; however, the BTAC only stores one target address per return instruction. Since procedures may be called from many places in a program, a return's target address is not static and varies based on from where it was called. Therefore, it is generally better to use the CRS for predicting returns, so that the accuracy of the prediction is much higher.

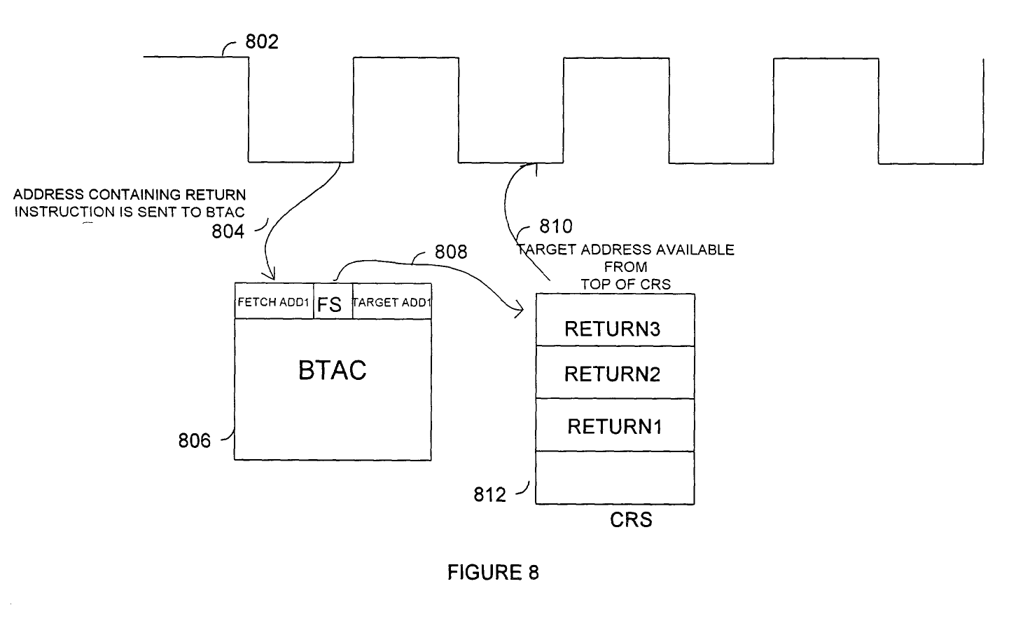

One embodiment of the current invention reduces latency by combining the quicker prediction capabilities of a BTAC with the accurate prediction of the CRS. When an entry is added to a BTAC, based on an embodiment of this invention, a flag is added to this entry that indicates whether the entry corresponds to a return instruction from a CRS. In one embodiment, the flag may be a single extra bit in the BTAC entry, which may be set to zero or one. FIG. 8 illustrates how the latency may be reduced when using an embodiment of the current invention.

The waveform, 802, represents an example of a clock voltage waveform. When a branch occurs, 804, the addresses in BTAC, 806, are associatively compared. If a fetch address matches the branch address, a flag determines whether the target address in the BTAC or the top of the CRS is used. If the flag, 808, is set, the address, return3, 810, at the top of the CRS, 812, is taken with no delay. This prevents latency in the pipeline and as a result, the overall performance is improved.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) A method for reducing latency during a branch that references a CRS comprising:
a) adding an electrical flag to each entry contained in a BTAC;
b) recognizing said electrical flag in said entry when a branch operation occurs;
c) wherein said electrical flag determines whether a target address in said BTAC should be used as the target of said branch operation or whether an address at the top of said CRS should be used as the target of said branch operation.

2) The method as in claim 1 wherein:
said address at the top of said CRS is used when said flag is set to a digital value of one.

3) The method as in claim 1 wherein:
said address at the top of said CRS is used when said flag is set to a digital value of zero.

4) A circuit for reducing latency during a branch that references a CRS comprising:
a BTAC, said BTAC having space for a first set of entries;
a CRS, said CRS having space for a second set of entries;
a group of electrical flags;
wherein an electrical flag from said group of flags is included in each entry of said first set of entries;
such that said electrical flag determines whether a target address in said BTAC should be used as the target of a branch operation or whether a address at the top of said CRS should be used as the target of said branch operation.

5) The circuit as in claim 4 wherein:
said address at the top of said CRS is used when said flag is set to a digital value of one.

6) The circuit as in claim 4 wherein:
said address at the top of said CRS is used when said flag is set to a digital value of zero.

7) A circuit for reducing latency during a branch that references a CRS comprising:
a BTAC, said BTAC having space for a first set of entries;
a CRS, said CRS having space for a second set of entries;
a means for tagging all entries in said first set of entries to indicate whether any entry in first set of entries references said CRS;
a means for identifying any entry in said first set of entries that references said CRS;
such that when an entry in said first set of entries is identified as containing a reference to said CRS, an address at the top of the CRS is used.

8) The circuit as in claim 7 wherein:
said means for tagging all entries in said first set of entries is achieved by storing an electrical value in all entries in said first set of entries.

9) The circuit as in claim 7 wherein:
said means for identifying any entry in said first set of entries is achieved by reading an electrical value stored in any entry in said first set of entries.
